(19) United States
(12) Patent Application Publication
(10) Pub. No.: US 2025/0312906 A1
(43) Pub. Date: Oct. 9, 2025

(54) DRIVER MEMBER FOR A FASTENING TOOL

(71) Applicant: Black & Decker, Inc., New Britain, CT (US)

(72) Inventors: Luke Moloznik, Baltimore, MD (US); Daryl S. Meredith, York, PA (US); Jared W. Rondeau, Colchester, CT (US)

(21) Appl. No.: 19/244,384

(22) Filed: Jun. 20, 2025

Related U.S. Application Data
(63) Continuation of application No. PCT/US2023/086409, filed on Dec. 29, 2023.
(60) Provisional application No. 63/435,849, filed on Dec. 29, 2022.

(51) Int. Cl. B25C 1/06; B25C 1/00

(52) U.S. Cl. CPC B25C 1/06; B25C 1/001

(57) ABSTRACT

A fastening tool having a driver member having a driver body that is configured to overlap the magazine assembly in a direction parallel to the drive axis during a drive stroke of a drive cycle.

### CROSS-REFERENCE TO RELATED APPLICATIONS

The present application is a continuation of international application PCT/US2023/086409 filed on Dec. 29,2023 which claims priority under 35 U.S.C. § 119 to U.S. Provisional Application Ser. No. 63/435,849 entitled “Driver Member for a Fastening Tool”, filed Dec. 29, 2022. The entirety of the above application is incorporated herein by reference.

### BACKGROUND OF THE INVENTION

### Field of the Invention

The present invention relates, in general, to the field of power tools. In particular, the present invention relates to a fastening or driving tool, such as a nailer and more particularly to improvements in reducing the size and weight of the tool. In particular, the present invention relates to a fastening tool having a driver member straddles the magazine during the drive cycle.

### Description of the Related Art

Different types of fastening tools are known including portable pneumatically actuated devices, electrically actuated devices, hammer actuated devices, manual actuated devices, etc. Fastening tools, such as power nailers and staplers have become relatively common place in the construction industry. Battery-powered nailers are popular in the market.

A common characteristic of all these types of fastening tools is the provision of a drive track, a fastener driving element mounted in the drive track and a magazine assembly for receiving a supply of fasteners in stick formation and feeding successive leading fasteners in the stick laterally through a fastener channel and into the drive track to be driven outwardly thereof by the fastener driving element.

In a fastening tool, for example, fasteners, are driven into a workpiece by a driver blade or driver member through a process known as a “drive” or “drive cycle”. Generally, a drive cycle involves the driver member striking a fastener head during a drive stroke to an extended position, and returning to a home or returned position during a return stroke.

Existing fastening tools 1, as shown in FIG. 1, have a driver member 2 as shown in FIGS. 2 and 3. The driver member 2 has a longitudinal body that includes a driver body 3 and an attached driver blade 4. The forward surface 5 of the driver body 3 is closed about the driver blade portion 4 and impacts a lower bumper in the return system. Also, the profile portion 6 of the driver body 3 has a width that is narrower than the rails 7. As such, the forward travel or drive stroke of the profile portion 6 and hence, the driver member 2 is limited. In particular, the driver body 3 of the driver member 2 remains inside of a plane P defined by an innermost surface of the fastener channel in the magazine 8 proximal to the housing, “the fastener channel plane”. The innermost surface of the fastener channel is opposite to the drive stroke direction. Only the driver blade portion 4 of the driver member 2 crosses the fastener channel plane P to strike the first or leading fastener in the drive track. The driver body 3 remains inside of the fastener channel plane P in order to avoid striking the second or next fastener in the magazine 8. Striking the first and second fasteners during a single drive cycle could result in one of the fasteners becoming jammed in the drive track or the nosepiece.

Often times, however, the fastening tools that are available may not provide the user with a desired degree of flexibility and freedom due to the size of the tool relative to the space in which the fastener is to be driven. As such, the user may be challenged to use the tool in small spaces.

Accordingly, there is a need in the art for a fastening tool that is smaller in length from tip of the nosepiece to the back end thereof, but is capable of reliably delivering the same force as larger fastening tools, and ensures that the upper driver member only strikes the leading fastener.

### SUMMARY OF THE INVENTION

In an embodiment of the present invention, a fastening tool driver member has a driver body that includes a profile portion that is greater in width than the fastener channel that is formed in the magazine and the nose. The greater width of the profile position allows the driver body to straddle or overlap the fastener channel. This places the rails and profile portion of the driver body outside of the drive path so that during the drive stroke, the driver body of the driver member bypasses the fastener channel when the driver blade strikes the leading fastener. As a result, the magazine portion of the fastener channel can be moved closer to the motor, reducing the length of the fastening tool.

In an embodiment of the present invention, the distance between the teeth on the profile portion of the driver body of the driver member is greater than the width of the fastener channel through the nose and the magazine assembly. Additionally, the driver body is open at the forward end on the fastener driving direction side of the tool. As such, during the drive stroke, the driver body is able to travel outside of or beyond the fastener channel plane P. More specifically, during the drive stroke, the driver body straddles the fastener channel through the nose and the magazine, and the forward surface of the driver member crosses the fastener channel plane P and overlaps the magazine assembly. Crossing the fastener channel plane P allows the driver member to maintain the same operating stroke as a fastening tool in which the driver body does not cross the fastener channel plane P and/or has a driver body with a greater length. As a result of the driver body overlapping the fastener channel through the nose and magazine assembly during the drive stroke of the driver member, the magazine assembly can be disposed closer to the motor. With the magazine assembly disposed closer to the motor, the fastening tool can have a shorter length than a tool in which the driver body does not overlap the fastener channel.

In an embodiment, the tool includes a housing; a drive channel disposed through the housing; a nosepiece connected to the housing and having a nose portion; a magazine carried by the housing, the magazine configured to hold a plurality of fasteners in a fastener channel and to present a lead fastener of the plurality of fasteners into a drive channel; and a driver member provided in the housing and configured for translational movement within the drive channel to drive the lead fastener along a drive axis and into a workpiece during a drive stroke, the driver member having a driver body and a driver blade connected thereto, at least a portion of the driver body overlapping the fastener channel during a drive stroke.

The fastener channel can extend into the nose portion such that a portion of the fastener channel is in the magazine and a portion of the fastener channel is in the nose and the driver body can overlap the fastener channel in a direction parallel to the drive axis. The fastener channel can intersect the drive channel in the housing.

The driver body can also overlap the fastener channel in the nose portion in a direction perpendicular to the drive axis.

The driver body is open at a forward end and the forward end of the driver body overlaps the fastener channel during a drive stroke. The driver body being open at the forward end allows it to straddle the fastener channel in a lateral direction with respect to the drive axis. The driver blade is also disposed through the forward end.

In an embodiment, the tool includes a housing; a nosepiece connected to a forward end of the housing and having a nose portion; a motor disposed in the housing; a flywheel rotatably driven by the motor and having an outer rim; a magazine assembly carried by the housing and including a fastener channel, the magazine assembly configured to hold a plurality of fasteners in the fastener channel and configured to present a lead fastener of the plurality of fasteners into a drive channel; and a driver member provided in the housing and configured for movement within the drive channel to drive the lead fastener along a drive axis into a workpiece during a drive stroke. The driver member has a driver body that includes a driver profile configured to be complementary to and mesh with the outer rim of the flywheel to transmit kinetic energy from the flywheel to the driver member to move the driver member within the drive channel. The driver body has a width defined by the driver profile that allows at least a portion of the driver body to overlap the fastener channel during the drive stroke.

At least a portion of the driver body overlaps the fastener channel in a direction parallel to the drive axis.

In an embodiment, the fastener channel can be non-parallel to the drive axis.

The outer rim of the flywheel has a plurality of grooves, and the driver profile comprises a plurality of teeth that mesh with the plurality of grooves in the flywheel.

The fastener channel also has a width and the width of the driver profile is greater than the width of the fastener channel.

The width of the driver profile is also greater than the width of the nose portion defining the fastener channel. Additionally, the distance between the teeth of the driver profile is greater than the width of the fastener channel.

The driver body can overlap a portion of the fastener channel in a direction perpendicular to the drive axis.

The driver body can overlap a portion of the nose in a direction perpendicular to the drive axis.

The driver body can be open at a forward end and can overlap the fastener channel during the drive stroke.

In an embodiment, the fastening tool may be a nailer or a stapler.

Additional features and benefits of the present invention are described, and will be apparent from, the accompanying drawings and the detailed description below.

### BRIEF DESCRIPTION OF THE DRAWINGS

The numerous advantages of the present invention may be better understood by those skilled in the art by reference to the accompanying Figures. In the drawings, like reference numerals designate corresponding parts throughout the several views.

FIG. 1 illustrates a prior art fastening tool;

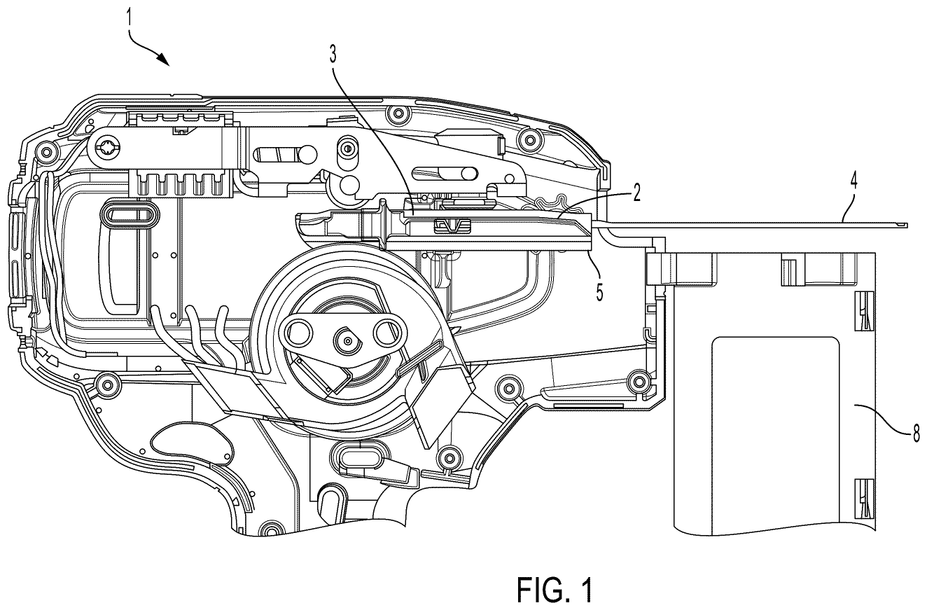

FIG. 2 illustrates illustrate a prior art driver member used in the tool of FIG. 1;

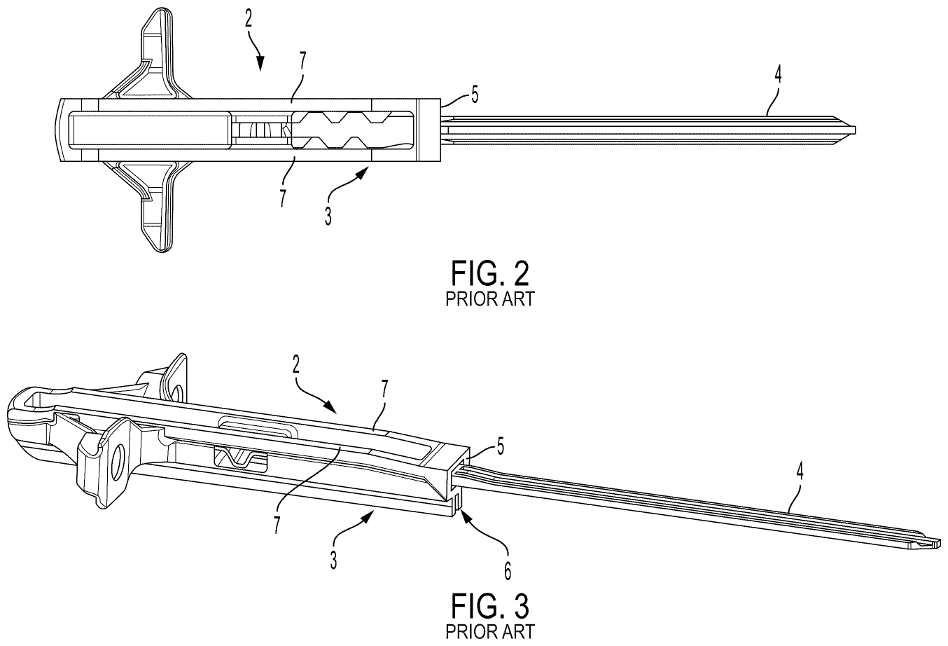

FIG. 3 illustrates a perspective view of a prior art driver member used in the tool of FIG. 1;

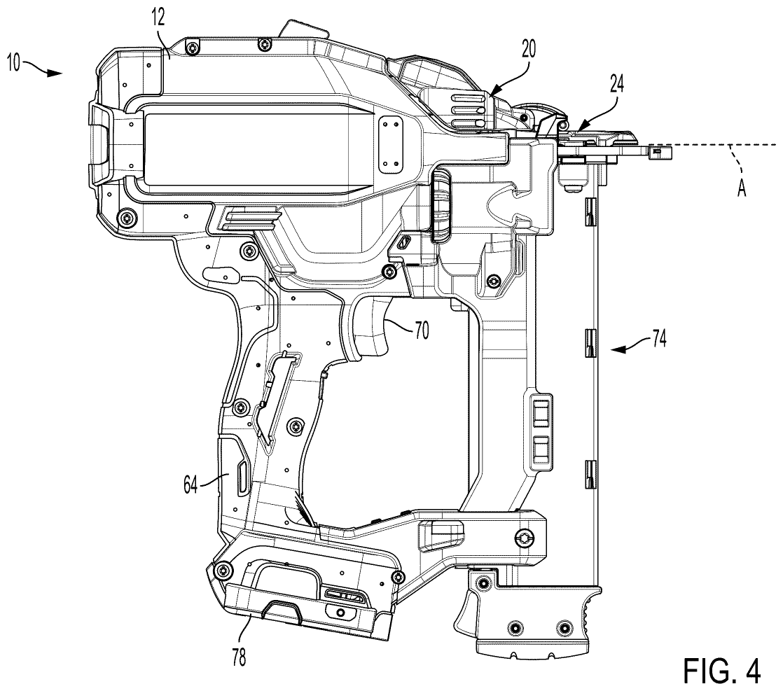

FIG. 4 illustrates an exemplary fastening tool according to a first embodiment of the present invention;

FIG. 5 illustrates the fastening tool of FIG. 4 with the housing removed;

FIG. 6 is a partial side view of the fastening tool of FIG. 4 with a portion of the housing removed;

FIG. 7 illustrates a first embodiment of a driver member in the fastening tool of FIG. 4;

FIGS. 8A-8B are top and plan views of the driver member of FIG. 7; and

FIG. 9 is a front cutaway view of the fastening tool of FIG. 4 and driver member of FIG. 7.

Corresponding reference names and/or numerals indicate corresponding parts throughout the several views of the drawings.

### DETAILED DESCRIPTION OF THE INVENTION

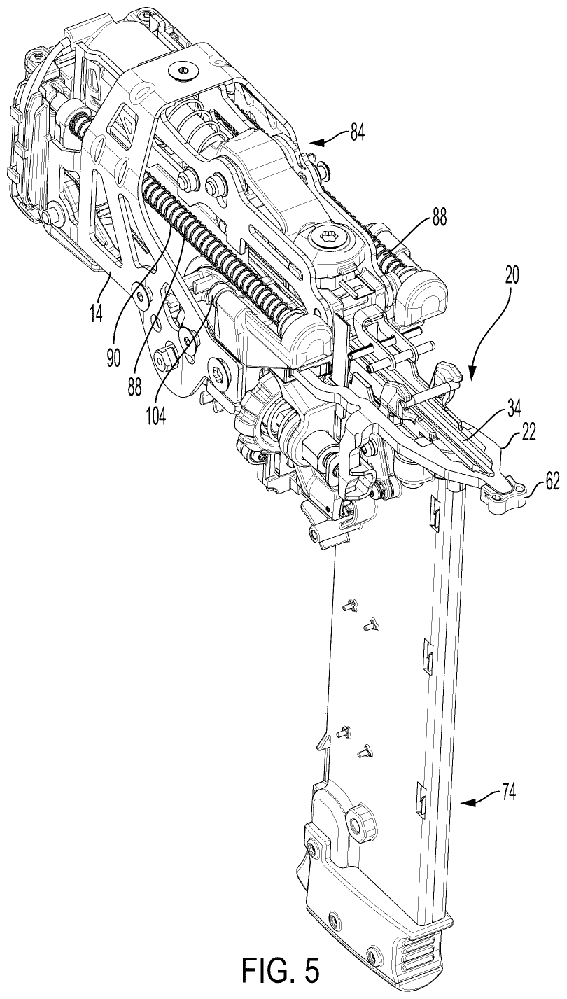

With reference to FIGS. 4, 5 and 6 of the drawings, a fastening tool 10 constructed in accordance with the teachings of the present invention is illustrated. According to several aspects, the fastening tool 10 is a cordless nailer for driving fasteners such as nails into a workpiece. The fastening tool 10 may include a housing 12, a backbone or frame 14 supported within the housing, a drive motor assembly 16, a controller or control module 18, a nosepiece assembly 20 extending forward of and fixed to the housing 12. The nosepiece assembly 20 includes a nose portion 22 that can be placed against the workpiece for driving a fastener. The nosepiece assembly 20 defines a fastener drive track 24 through which the fasteners F, such as nails or staples, are driven during a drive stroke. The fastener drive track 24 is connected to a drive channel 26. The drive channel 26 is defined within the housing interior and a within which, a driver member 30 is reciprocally mounted for movement along a fastening tool drive axis A, to drive the fastener.

The driver member 30 is movable within the drive channel relative to the frame 14 between a returned position and an extended position. The driver member 30 includes a driver body 32 at one end and a driver blade 34 for striking the head of a fastener during the drive stroke at an opposite end. The drive track 24 receives a first fastener of a collated strip of fasteners and guides the fastener out of the nosepiece assembly 20 when the fastener is struck by the driver blade to be driven into a workpiece.

In an embodiment, a no-mar tip 62 can be attached to the nose portion 22 of the nosepiece assembly 20 to prevent marring of the workpiece when the nose portion is placed against the workpiece for driving the fastener. Additionally, a door 28 is provided on the nose portion 22 to trap a portion the driver blade 34 between it and the nose portion 22.

A handle portion 64 of the tool extends from the housing 12. The handle 64 is configured to be received by a user's hand, thereby making the fastening tool portable. Additional portability can be achieved by constructing the housing from a lightweight yet durable material, such as magnesium. The handle 64 includes a connecting portion 66 and a housing extension 68 that extends substantially parallel to the handle 64.

A trigger assembly 70 is connected to the handle 64. The trigger assembly 70 serves as an actuation device or actuator for the fastening tool, and is constructed and arranged to actuate a switch assembly 72. The trigger assembly 70 may be coupled to the housing 12 and is configured to receive an input from the user, typically by way of the user's finger, that may be employed in conjunction with the trigger switch assembly 72 to generate a trigger signal that may be employed in part to initiate the drive cycle of the fastening tool to drive the fastener into the workpiece.

A magazine assembly 74 is carried by the housing 12 and is configured to hold a plurality of fasteners and configured to present a lead fastener of the plurality of fasteners into a drive channel 26. The magazine assembly 74 is connected to the nose portion 22 of the nosepiece assembly 20 at one end and is connected to the connecting portion 66 of the housing 12 at an opposite end. The magazine assembly 74 is constructed and arranged to feed successive leading fasteners along a fastener channel 76 and into the drive track 24. In an embodiment, the supply of fasteners can be collated fasteners. The supply of fasteners is urged toward the drive track 24 by at least one magazine pusher or a plurality of magazine pushers (not shown) that are slidably disposed in the magazine assembly 74. The magazine pusher travels along the magazine pusher path or the fastener channel 76. The fastener channel 76 has a width that accommodates the fasteners. The fastener channel 76 extends into the nose portion 22 of the nosepiece assembly 20. The magazine pusher is biased towards the drive track 24 by a spring or plurality of springs. The magazine pusher engages the last fastener in the supply of fasteners to thereby feed individual fasteners from the fastener channel 76 in the magazine assembly 74 to the fastener channel in the nose portion 22.

In an embodiment, the fastening tool 10 is battery powered. A battery mount 78 is provided for removably mounting a battery pack (not shown) to the fastening tool 10.

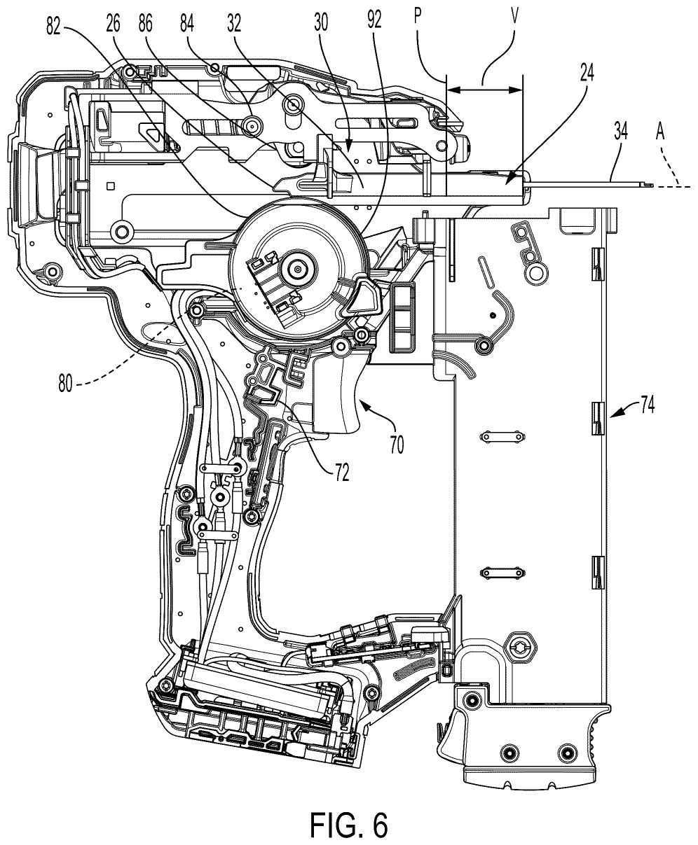

With additional reference to FIG. 5, the frame 14 may be a structural element upon which the drive motor assembly 16, control module 18, the nosepiece assembly 20 and/or the magazine assembly 74 may be fully or partially mounted.

The drive motor assembly 16 may include a motor 80 and a flywheel 82 that are operable for propelling the driver member 30 in a first direction along the drive axis A. In the embodiments herein, the first direction is a forward direction toward the nose portion 22 of the tool 10. The motor 80 is operably coupled to the flywheel 82 to rotate the flywheel 82. For example, the motor 80 can be an outer rotor brushless motor where the flywheel 82 is an integral part of the outer rotor. Alternatively, motor 80 can be drivingly coupled to flywheel 82 via a transmission (not shown).

Also coupled to the frame 14 are a follower assembly 84, including a pinch wheel or follower 86. The follower assembly 84 has a locked over-center position in which the driver member 30 is pinched between the follower 86 and the flywheel 82, subjecting the driver member to a pinch force when the driver member is in the stall position.

The drive motor assembly 16 also includes a return mechanism 88 that returns the driver member 30 to the returned position. The return mechanism can be in the form of return springs 90 that compress to absorb the return force applied by the driver member 30. The return springs 90 are compressed during the drive stroke and operate to return the driver member 30 to the returned position during the return stroke.

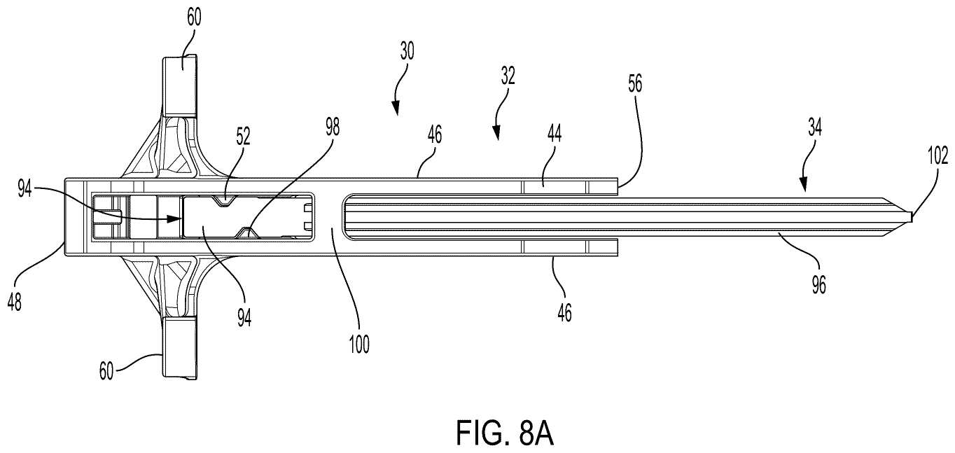

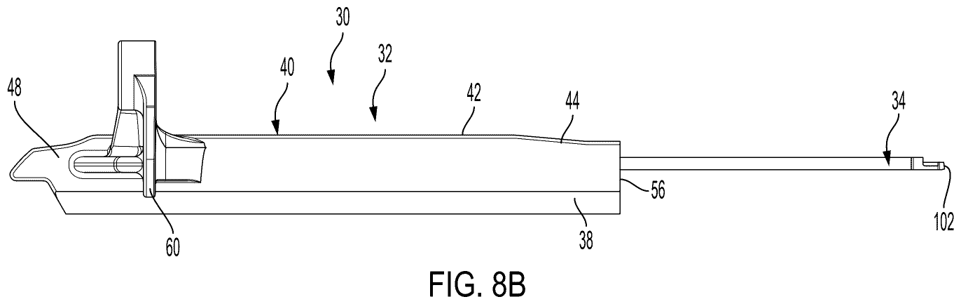

As shown in FIGS. 7, 8A and 8B, the driver body 32 of the driver member 30 may include a driver profile 36, a cam profile 40, an abutment 48, a blade recess 44, and a blade aperture 100.

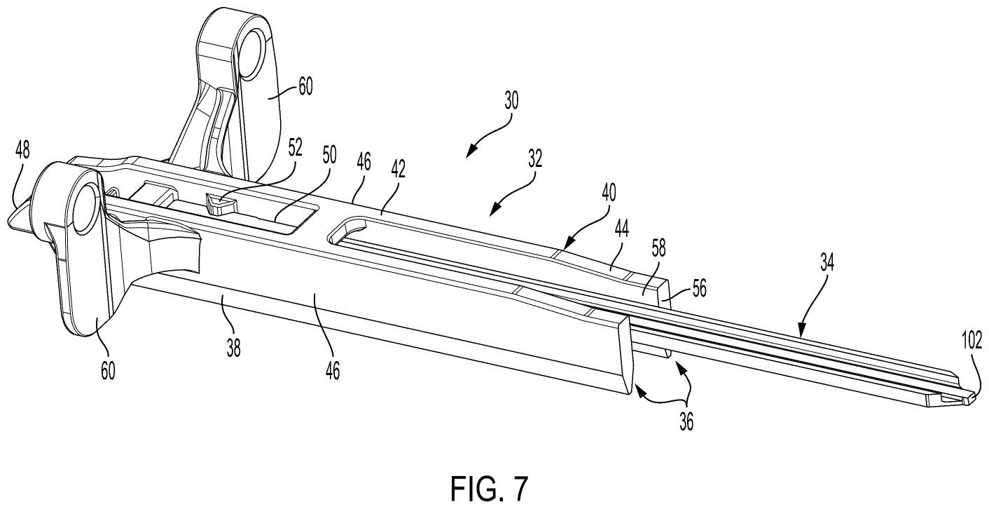

With additional reference to FIG. 6, the driver profile 36 is disposed on the flywheel side of driver member 30 and is shaped to engage the exterior surface of the outer rim 92 of the flywheel 82, so that the flywheel can deliver kinetic energy to propel the driver member 30.

The driver profile 36 forms a lower contour of the driver body 32 and is configured in a manner that is complementary to the exterior surface of outer rim 92 of the flywheel 82. In the particular example provided, the driver profile 36 includes a pair of longitudinally extending V-shaped teeth 38 that cooperate to form at least one passage therebetween. The exterior surface of the outer rim 92 of the flywheel 82 has complementary V-shaped teeth and grooves that mesh with the driver profile. As such, the driver profile 36 is configured for engaging grooves 52 on the flywheel 82. The outer rim 92 of the flywheel and the driver body, respectively, provide a space into which the V-shaped teeth, respectively, may extend as the exterior surface of the outer rim of the flywheel 82 and/or the driver profile 36 wear away to thereby ensure contact between the exterior surface and the driver profile along a substantial portion of the V-shaped teeth, rather than point contact.

To further control wear, a coating may be applied to the driver body 30 at one or more locations, such as over the driver profile 36 and the cam profile 40. The coating may be a type of carbide, such as titanium carbide, and may be applied via a plasma spray, for example. Alternatively, a ferric nitro carburizing heat treatment or coating can be used.

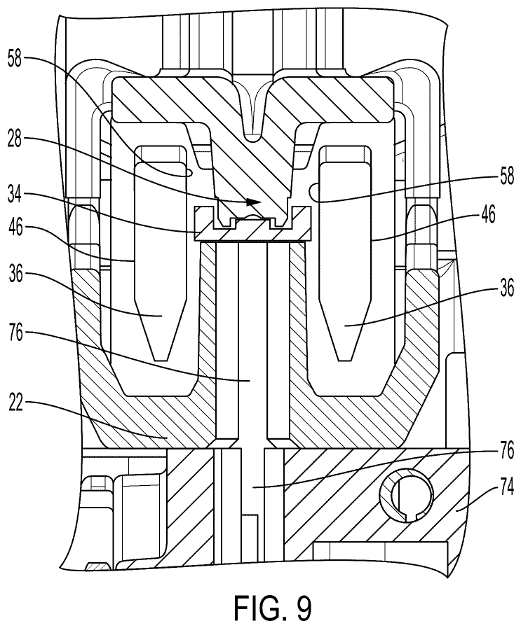

As shown in FIG. 9, the width of the driver body 30 defined by the driver profile 36 is greater than the width of the fastener channel 76. In particular, the space between the inner sides of the rails 58 and hence the driver profile 36 is greater than the width of the fastener channel. As such, during the drive stroke, not only the driver blade 34, but also the driver body 32 can overlap the fastener channel in a direction V parallel to the drive axis A, as shown in FIG. 6.

The point of the teeth 38 on the driver profile 36 are farther apart than the sides of the rails 46. Hence, the space between the teeth of the driver profile is also greater than width of the fastener channel.

As shown in FIG. 9, the fastener channel in the magazine extends through the nose portion 22 and intersects the drive channel in the housing. As such, the driver profile 36 also overlaps the fastener channel 76 in a direction perpendicular to the drive axis A. This is due to the open forward end of the driver body 32, which allows the driver body to straddle the fastener channel. The driver profile 36 also overlaps a portion of the nose portion 22 in a direction perpendicular to the drive axis A.

The cam profile 40 of the driver body 32 is located on the follower side of the driver member 30 opposite the driver profile 36. The cam profile 40 includes a raised cam profile 42 and a transition cam profile 44 against which the follower 86 engages. As the follower 86 rides up the transition cam profile 44, the pinching force acting on the driver member 30 between the follower 86 and the flywheel 82 increases. The raised and transition cam profiles can be formed on a pair of rails 46.

The driver body 32 also includes an end surface or abutment 48 on a side opposite the side from which the driver blade 34 extends. The abutment 48 may be configured to slope away from the driver profile 36.

The blade recess 50 may be a longitudinally extending cavity that may be disposed between the rails 46 of the cam profile 40. The blade recess may define a blade recess engagement structure 52 for engaging the driver blade. The blade recess engagement structure includes teeth 52 which may be located on opposite lateral sides of the blade recess, and first and second blade supports 54. In the example provided, the blade recess engagement structure defines a serpentine-shaped channel, having a flat bottom. The teeth 52 engage a corresponding surface at the rear or proximal portion of the driver blade 34. The first and second blade supports 54 may begin at a point that is within the blade recess proximate the blade aperture 100 and may extend in a direction toward the forward end 56 of the driver body 32.

The driver body 32 is open at the forward end 56 and there is a space between the inner sides 58 of the rails and the driver blade 34. The opening extends longitudinally through a portion of the driver body and defines the blade recess 50 at an opposite closed end. The open forward end 56 is defined by the rails. The driver body 32 can be closed at the abutment 48 at the rear end.

The driver body 32 has a pair of projections or ears 60 that extend laterally on each side. The ears 60 are used to stop forward movement of the driver member 30 after a fastener has been installed in a workpiece.

The ears 60 define a contact surface that may be planar in shape, and which may be generally perpendicular to the longitudinal axis of the driver member 30. In an embodiment, the pair of ears 60 are generally parallel to one another and disposed on opposite lateral sides of the driver profile 36.

The driver body 32 may be unitarily formed in an appropriate process, such as investment casting, from a suitable material, such as a ferromagnetic material. In an embodiment, the driver body 32 and the driver blade 34 can be formed of a metal including, but not limited to steel and titanium.

The driver blade 34 itself may include a retaining portion 94 and a blade body 96. The retaining portion 94 secures the driver blade 30 to the driver body 32 and may be configured to inhibit movement of the driver blade relative to the driver body in a direction that is generally transverse to the longitudinal axis of the driver member.

The retaining portion 94 may include a corresponding blade engagement structure that is configured to engage the blade recess engagement structure or teeth 52 in the driver body. In the particular example provided, the corresponding blade engagement structure includes a plurality of blade teeth 98 that are received into the serpentine-shaped channel of the blade recess 50 and into engagement with the teeth 52 that form the blade recess engagement structure. Engagement of the blade recess engagement structure or teeth 52 and the blade engagement teeth 98 substantially inhibits motion between the driver blade 34 and the driver body 96.

Returning to FIGS. 7, 8A and 8B, the blade portion 34 extends from the retaining portion 94 and through the blade aperture 100 in the driver body 32. The blade body 96 of the driver blade 34 may include a tip portion 102 that is tapered in a conventional manner (e.g., on the side against which the fasteners in the magazine assembly 74 are fed) and on its laterally opposite sides.

In addition to the driver member 30 being movable along a drive axis A from a returned position to an extended position to drive a fastener, the driver member 30 is also movable in a radial direction relative to the flywheel 82 between an engaged or firing position (FIG. 6) and a home position (FIG. 4). In the firing position, the driver member 30 is drivingly engaged against the flywheel 82. In the home position, the driver member 30 is radially further away from the flywheel 82 than in the firing position.

The distal end of the driver blade 34 can contact against the head of a fastener and drive the fastener as the driver member 30 moves to its axially extended position, where the ears 60 of the driver member 30 can contact against housing bumper members 104.

In operation, the magazine assembly 74 sequentially feeds the fasteners into the nosepiece assembly 20 and positions fasteners in line with the driver member 30. The drive motor assembly 16 may be actuated by the control module 18 to cause the driver member 30 to translate and impact a fastener in the nosepiece assembly so that the fastener may be driven into a workpiece. Actuation of the motor 80 may be by use of electrical energy from the battery pack (not shown) to operate the motor 80 of the drive motor assembly 16, the control module 18 and the trigger assembly 70. The motor 80 is employed to drive the flywheel 82.

The control module 18 is configured to control a supply of power from the battery to the motor 80 to initiate and activate the drive cycle upon receipt of the trigger signal. In an embodiment, the control module 18 moves the follower 86 that is associated with the follower assembly 84, which squeezes the driver member into engagement with the flywheel so that energy may be transferred from the flywheel to the driver member to cause the driver member to translate. In this way, the control module 18 is arranged to initiate frictional engagement between the outer rim 92 of the flywheel 82 and the driver profile 36 to transmit energy from the flywheel 82 to the driver member 30 to accelerate the driver along the drive axis A for the drive stroke. The nosepiece assembly 20 guides the fastener as it is being driven into the workpiece. The return mechanism 54 biases the driver member into a returned position.

With driver body 32 being open at the forward end 56 on the fastener driving direction side of the tool, during the drive stroke, the driver body is able to travel outside of or beyond the fastener channel plane P. During the drive stroke, and while the follower assembly squeezes the driver member into engagement with the flywheel, the driver body 32 straddles the fastener channel 76 through the nose portion 22 and the magazine 74, and the forward surface 56 of the driver member 30 crosses the fastener channel plane P and overlaps the fastener channel in a direction parallel to the drive axis A.

While the fastening tool is illustrated as being electrically powered by a suitable power source, such as a battery pack, those skilled in the art will appreciate that the invention, in its broader aspects, may be constructed somewhat differently and that aspects of the present invention may have applicability to any type of portable tool. Further, the fastening tool in the embodiment described herein can be powered by a number of other power sources. For example, power sources for the fastening tool can be manual, pneumatic, electric, combustion, solar or use other (or multiple) sources of energy.

Furthermore, while aspects of the present invention are described herein and illustrated in the accompanying drawings in the context of a nailer, those of ordinary skill in the art will appreciate that the invention, in its broadest aspects, has further applicability. For example, the drive motor assembly may also be employed in various other mechanisms that use reciprocating motion, including rotary hammers, hole forming tools, such as punches, and riveting tools, such as those that install deformation rivets.

While aspects of the present invention are described herein and illustrated in the accompanying drawings in the context of a fastening tool, those of ordinary skill in the art will appreciate that the invention, in its broadest aspects, has further applicability.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made, and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

We claim:

1. A tool comprising:
a housing;
a drive channel disposed through the housing;
a nosepiece connected to the housing and having a nose portion;
a magazine carried by the housing, the magazine configured to hold a plurality of fasteners in a fastener channel and to present a lead fastener of the plurality of fasteners into a drive channel; and
a driver member provided in the housing and configured for translational movement within the drive channel to drive the lead fastener along a drive axis and into a workpiece during a drive stroke, the driver member having a driver body and a driver blade connected thereto, at least a portion of the driver body overlapping the fastener channel during a drive stroke.

2. The tool according to claim 1, wherein the driver body overlaps the fastener channel in a direction parallel to the drive axis.

3. The tool according to claim 1, wherein the fastener channel extends into the nose portion.

4. The tool according to claim 3, wherein the fastener channel intersects the drive channel in the housing.

5. The tool according to claim 3, wherein the driver body overlaps the fastener channel in a direction parallel to the drive axis.

6. The tool according to claim 3, wherein a portion of the fastener channel is in the magazine and a portion of the fastener channel is in the nose.

7. The tool according to claim 6, wherein the driver body overlaps the portion of the fastener channel in the nose portion in a direction perpendicular to the drive axis.

8. The tool according to claim 1, wherein the driver body is open at a forward end and the portion of the driver body overlapping the fastener channel during a drive stroke is the forward end.

9. The tool according to claim 1, wherein the driver body is open at the forward end so as to straddle the fastener channel in a lateral direction with respect to the drive axis.

10. The tool according to claim 9, wherein the driver blade is disposed through the forward end.

11. A tool comprising:
a housing;
a nosepiece connected to a forward end of the housing and having a nose portion;
a motor disposed in the housing;
a flywheel rotatably driven by the motor and having an outer rim;
a magazine assembly carried by the housing and including a fastener channel having a width, the magazine assembly configured to hold a plurality of fasteners in the fastener channel and configured to present a lead fastener of the plurality of fasteners into a drive channel; and
a driver member provided in the housing and configured for movement within the drive channel to drive the lead fastener along a drive axis into a workpiece during a drive stroke, the driver member having a driver body with a driver profile configured to be complementary to and mesh with the outer rim of the flywheel to transmit kinetic energy from the flywheel to the driver member to move the driver member within the drive channel, the driver profile having a width that allows at least a portion of the driver body to overlap the fastener channel during the drive stroke.

12. The tool according to claim 11, wherein the at least a portion of the driver body overlaps the fastener channel in a direction parallel to the drive axis.

13. The tool according to claim 11, wherein the fastener channel is non-parallel to the drive axis.

14. The tool according to claim 11, wherein the outer rim of the flywheel has a plurality of grooves, and the driver profile comprises a plurality of teeth that mesh with the plurality of grooves in the flywheel.

15. The tool according to claim 11, wherein the width of the driver profile is greater than the width of the fastener channel.

16. The tool according to claim 11, wherein the width of the driver profile is greater than the width of the nose portion defining the fastener channel;

17. The tool according to claim 14, wherein the distance between the teeth of the driver profile is greater than the width of the fastener channel.

18. The tool according to claim 11, wherein the driver body overlaps a portion of the fastener channel in a direction perpendicular to the drive axis.

19. The tool according to claim 11, wherein the driver body overlaps a portion of the nose portion in a direction perpendicular to the drive axis.

20. The tool according to claim 11, wherein the driver body is open at a forward end and the portion of the driver body overlapping the fastener channel during the drive stroke is the forward end.
